(19) United States
(12) Patent Application Publication
(10) Pub. No.: US 2024/0411069 A1
(43) Pub. Date: Dec. 12, 2024

(54) CONTROLLED ANTI-BLAZE ON STEPPED DIFFRACTION GRATING

(71) Applicant: Snap Inc., Santa Monica, CA (US)

(72) Inventors: Akheelesh Kumar Abeeluck, Phoenix, AZ (US); Alexander Drayton, Abingdon (GB); Marcell Kiss, Didcot (GB); Parashara Panduranga, Banbury (GB)

(21) Appl. No.: 18/670,486

(22) Filed: May 21, 2024

Related U.S. Application Data
(60) Provisional application No. 63/472,463, filed on Jun. 12, 2023.

(51) Int. Cl. G02B 5/18

(52) U.S. Cl. CPC G02B 5/1857; G02B 5/1866

(57) ABSTRACT

A stepped diffraction grating and method for manufacturer thereof are disclosed. A plurality of parallel grating lines are each formed on a substrate surface by forming a plurality of stacked layers of optically transmissive material. In cross-section, each grating line has an upper layer having an upper surface having a first end and a second end; a bottom layer having a bottom surface abutting the substrate surface and an upper surface having a first end and a second end; a rising staircase portion extending at a rising staircase angle between 10 degrees and 60 degrees; and a falling staircase portion extending at a falling staircase angle between the rising staircase angle and 89 degrees.

### RELATED APPLICATIONS

This application claims the benefit of priority to U.S. Provisional Application Ser. No. 63/472,463, filed Jun. 12, 2023, which is incorporated herein by reference in its entirety.

### TECHNICAL FIELD

The present disclosure relates generally to optical structures and more particularly to diffraction gratings.

### BACKGROUND

Diffraction gratings, such as input gratings for optical waveguides, can be manufactured to feature grating line structures at sub-micron scales in order to diffract light at very high uniformity. However, due to their small scale and their structure, the individual lines of the diffractive gratings are prone to deformation during the manufacturing process. Furthermore, if a grating manufactured at very small scale is coated with a further layer of material as part of the manufacturing process, the structure of the grating may also result in the coating being non-uniform in thickness over the various portions of the grating lines.

In addition, when light is incident on an input grating of a waveguide, the light is coupled into the waveguide and undergoes total internal reflection within the waveguide body. While the light is being internally reflected, it can be reflected into the reverse side of the input grating, which can result in a portion of the internally reflected light being coupled back out of the waveguide, thereby reducing the efficiency of the waveguide.

Typically, a goal in manufacturing a blazed diffraction grating is to achieve grating lines having a blaze face oriented toward the underlying substrate surface at a predetermined rising staircase angle, and an anti-blaze face (opposite the blaze face) oriented perpendicular to the substrate surface. When an anti-blaze face is formed at a non-perpendicular angle to the substrate surface, this is typically as a result of imperfections in the manufacturing process. For example, International Patent Application No. PCT/GB2014/050019, filed Jan. 6, 2014 and published as WO 2014/108670 A1, describes the desirability of forming a grating line or “groove” having a perpendicular anti-blaze angle relative to the substrate surface.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates a plan view of a stepped diffraction grating having multiple parallel grating lines, illustrating principles relevant to some examples.

FIG. 2 illustrates a cross-sectional view through plane A of a grating line of the stepped diffraction grating having a 90-degree falling staircase portion, illustrating principles relevant to some examples.

FIG. 3 illustrates a cross-sectional view of the grating line of FIG. 2 deformed during manufacturing, illustrating principles relevant to some examples.

FIG. 4 illustrates a cross-sectional view of the grating line of FIG. 2 covered by a uniform coating, illustrating principles relevant to some examples.

FIG. 5 illustrates a cross-sectional view of the grating line of FIG. 2 covered by a non-uniform coating, illustrating principles relevant to some examples.

FIG. 6 illustrates a rising staircase angle and a falling staircase angle of the cross-sectional view of the grating line of FIG. 2, illustrating principles relevant to some examples.

FIG. 7 illustrates a cross-sectional view of a grating line having a falling staircase angle less than 90 degrees, in accordance with some examples.

FIG. 8 illustrates a cross-sectional view of a grating line having a falling staircase angle of 60 degrees, in accordance with some examples.

FIG. 9 illustrates a cross-sectional view of a grating line having a stepped falling staircase portion having a falling staircase angle of less than 90 degrees, in accordance with some examples.

FIG. 10 illustrates a cross-sectional view of a master and a working stamp for forming a grating line, in accordance with some examples.

FIG. 11 illustrates a method 1100 for manufacturing a stepped diffraction grating, in accordance with some examples.

FIG. 12 illustrates a cross-sectional view of a grating line having non-perpendicular layer faces, in accordance with some examples.

FIG. 13 illustrates a cross-sectional view of the grating line of FIG. 12 covered by a uniform coating, in accordance with some examples.

FIG. 14 illustrates a cross-sectional view of light entering and reflecting within a waveguide having an input grating, illustrating principles relevant to some examples.

FIG. 15 illustrates a cross-sectional view of light entering and reflecting out of the waveguide of FIG. 14 along a first back-coupling path, illustrating principles relevant to some examples.

FIG. 16 illustrates a cross-sectional view of light entering and reflecting out of the waveguide of FIG. 14 along a second back-coupling path, illustrating principles relevant to some examples.

FIG. 17 illustrates two figures of merit, FOM1 and FOM2, graphed against the falling staircase angle as tested in a simulation of stepped diffraction gratings according to some examples.

FIG. 18 illustrates a plan view of a stepped diffraction grating having parallel grating lines configured to propagate light along a light propagation path, in accordance with some examples.

FIG. 19 illustrates a plan view of a stepped diffraction grating having parallel grating lines configured to propagate light along multiple light propagation paths, in accordance with some examples.

### DETAILED DESCRIPTION

Examples are described herein that provide stepped diffraction gratings having controlled falling staircase portions and methods for the manufacture thereof. A grating line of a stepped diffraction grating is typically formed in a roughly triangular shape, with a base resting on a substrate surface, a rising staircase portion rising to an apex at a rising staircase angle, and a falling staircase portion extending upward from the base to the apex at a right angle (90 degrees, also called a perpendicular angle herein). However, examples described herein provide a grating line having a falling staircase portion having a falling staircase angle of less than 90 degrees (also called sloped, slanted, or diagonal herein). Methods are also described for the manufacture of grating lines of a stepped diffraction grating having a falling staircase portion having a falling staircase angle of less than 90 degrees.

By providing grating lines having a sloped falling staircase portion, some examples described herein may attempt to address one or more of the technical problems described above. Deformation of the grating line during manufacture, such as deformation of the upper portions and/or of the falling staircase portion when removing the working stamp used to imprint the shape of the grating line into a moldable material, may be reduced due to the more gradual slope of the sides of the grating line. When a coating is deposited over an upper face of the grating line, such as a coating of a reflective material or a high refractive index material or a multilayer stack of dielectric materials, the uniformity of the coating can be improved and/or convexities in the coating may be reduced or eliminated by the sloped shape of the grating line. Finally, when a stepped diffraction grating having sloped falling staircase portions of its grating lines is used as an input grating to a waveguide, the amount of light back-coupling out of the waveguide may be reduced for some wavelengths of light and for some falling staircase angles. This may increase the amount of light propagated to its target location within the waveguide body, and/or may also reduce the presence of ghost images caused by light back-coupling out of the waveguide and reflecting back into the waveguide at a different location.

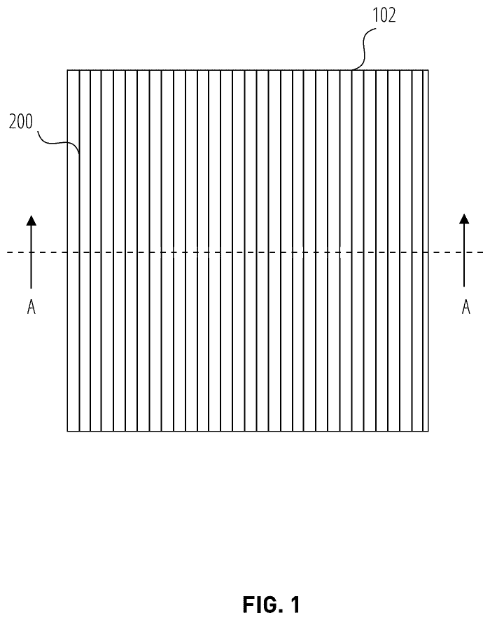

FIG. 1 shows an overhead plan view of an example stepped diffraction grating 102 consisting of multiple parallel grating lines 200. Diffraction gratings can be used for a number of useful applications in the field of optics, including operating to redirect light in relation to waveguides.

The example stepped diffraction grating 102 shown in FIG. 1 is illustrated as having only a few grating lines 200 for the sake of simplicity and visual clarity. However, it will be appreciated that some examples of stepped diffraction gratings 102 described herein may include hundreds or thousands of grating lines 200. For example, some stepped diffraction gratings 102 have a period (the width of a grating line 200 plus the width of a gap between adjacent grating lines 200) on the nanometer scale, such as 300 nm. This means that a stepped diffraction grating 102 having a width of 5 mm would include more than 15,000 grating lines 200. The nanometer-scale structures and fabrication techniques described herein may attempt to address one or more technical challenges arising in that context.

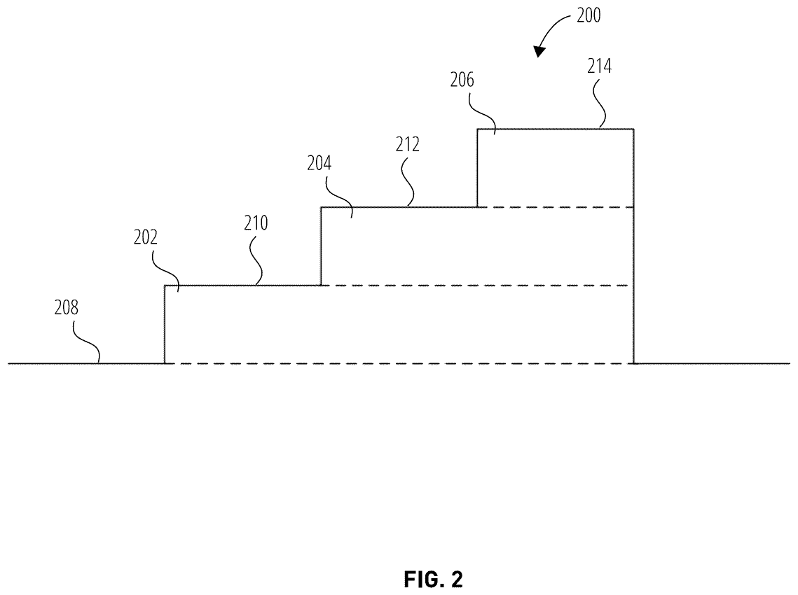

FIG. 2 shows a cross-sectional view, through plane A of FIG. 1, of a grating line 200 of the stepped diffraction grating 102 having a perpendicular falling staircase angle of its falling staircase portion. Plane A is normal to the multiple parallel grating lines 200 of the stepped diffraction grating 102.

In cross-section, the grating line 200 includes a bottom layer 202 formed on a substrate surface 208, an intermediate layer 204 formed on an upper surface 210 of the bottom layer 202, and an upper layer 206 formed on an upper surface 212 of the intermediate layer 204. An upper surface 214 of the upper layer 206 defines the height of the grating line. The layers 202, 204, 206 have left sides forming a rising staircase portion and right sides forming a falling staircase portion. It will be appreciated that the number of layers forming the steps of the grating line can be as low as two or arbitrarily high—as the number of steps increases, the stepped grating line more closely approximates a true blazed structure (i.e., a structure having a straight line ramp forming the rising staircase portion).

In some examples, the grating line 200 is formed from an optically transmissive material, such as a transparent or semi-transparent polymer. The optically transmissive material may be selected based on factors such as its mechanical properties during molding and curing, and its refractive index. In some examples, the optically transmissive material may be a resin polymer, such as a resin polymer doped with nanoparticles.

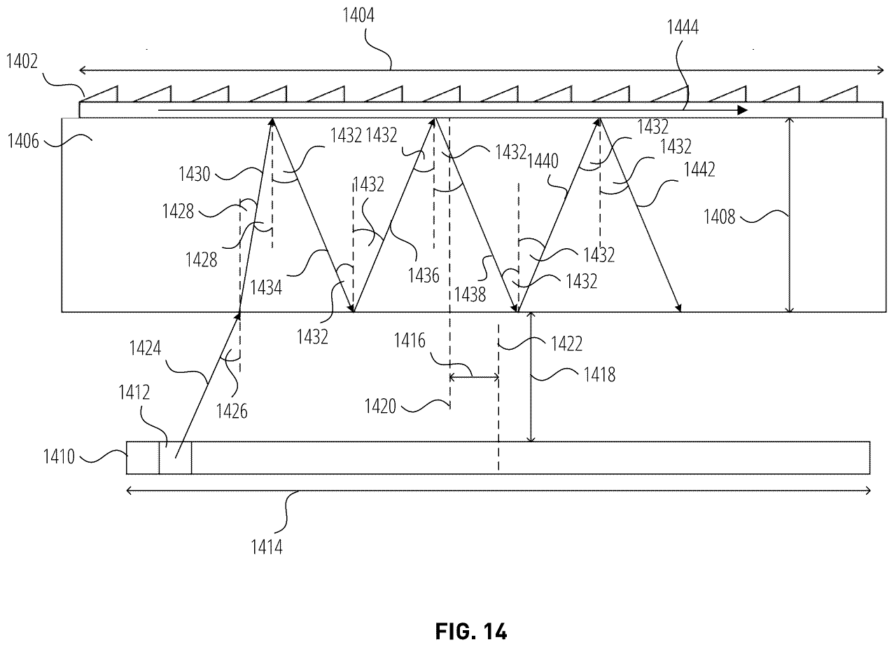

In operation, the grating line 200 operates in tandem with the other grating lines 200 of the stepped diffraction grating 102 to diffract light passing through it, thereby redirecting the light. Some aspects of the operation of the stepped diffraction grating 102 and its individual grating lines 200 in diffracting light are described below with reference to FIG. 14 to FIG. 16.

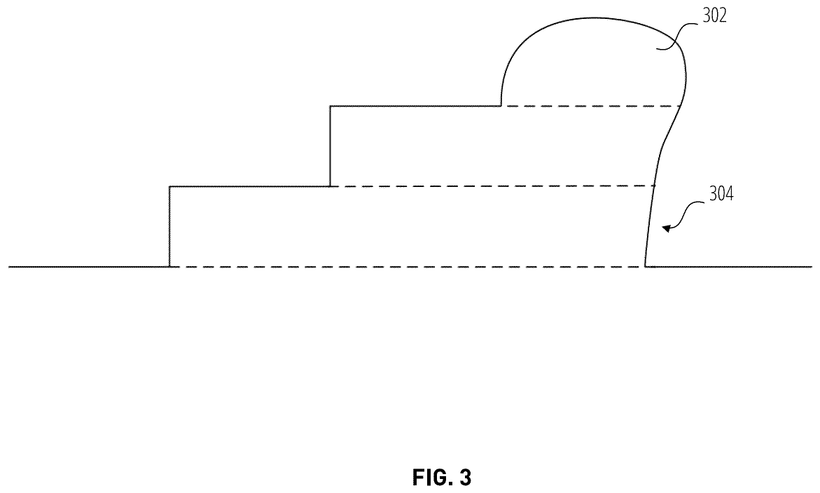

FIG. 3 shows a grating line in cross-section as in FIG. 2, wherein the grating line has been deformed during the manufacturing process. Deformation can result from various processes used to form the nanometer-scale grating lines. In this example, the top layer of the grating line has a deformation 302 displacing portions of the top layer to the right side and creating a concavity 304 underneath the top layer. This deformation 302 could be caused, in some contexts, by the material used to form the grating line being subjected to shearing forces when a mold is lifted away from the substrate surface.

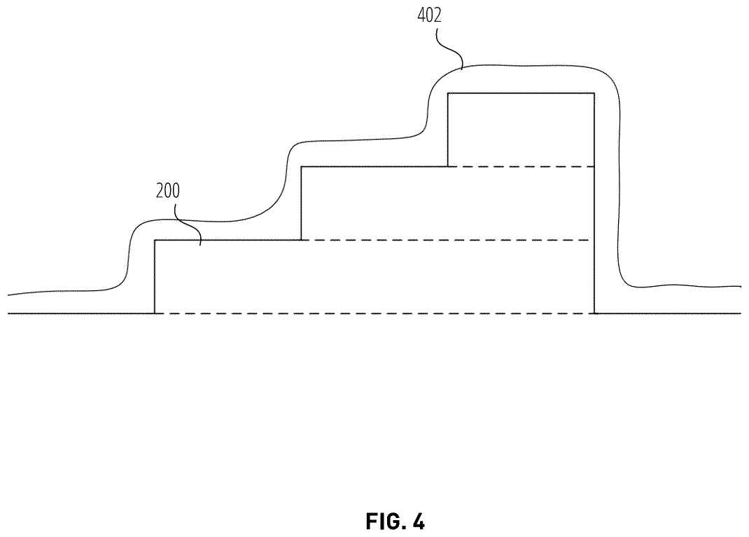

FIG. 4 shows the grating line 200 covered by a uniform coating 402. The coating 402 may be deposited over the upper side of the grating line 200 following formation of the grating line 200, where the upper side can be regarded as all faces of the grating line exposed to the environment above (such as upper surfaces 210, 212, 214, as well as the left and right faces of each layer 202, 204, 206). The coating 402 may be a coating of a reflective material, a high refractive index material such as titanium dioxide (TiO₂), a coating of another functional material, a multilayer stack such as alternating layers of TiO2 and SiO2, or a multilayer stack of other functional materials.

The coating 402 shown in FIG. 4 is close to an ideal coating, insofar as it is relatively uniform over the upper side of the grating line 200. However, in practice, when depositing coatings of materials at the nanometer scales that characterize some example grating lines described herein, achieving a high degree of uniformity in the distribution and thickness of the coating 402 presents technical challenges.

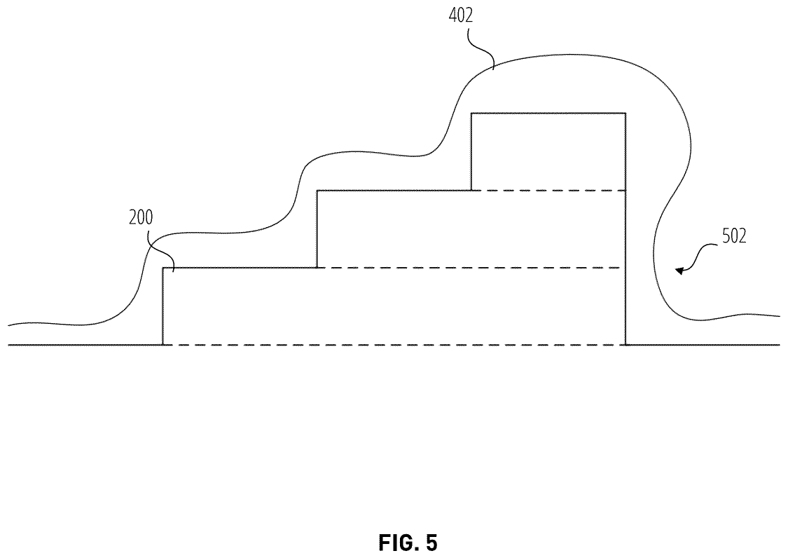

FIG. 5 shows a non-uniform coating 402 deposited over the grating line 200, as is more typical of actual manufacturing results. The 90-degree cliff formed by the falling staircase portion can result in excess thickness of the coating material forming on various portions of the grating line 200 in order to ensure that at least some of the coating material is deposited onto the perpendicular side of the falling staircase portion. Furthermore, the tendency of the coating material to accumulate at acute concave corners and to deposit more thinly on perpendicular surfaces may result in concavities such as concavity 502. One or both of these nonuniformities can be exacerbated by deformation such as the deformation 302 and concavity 304 shown in FIG. 3, which can result from defects introduced during manufacturing. These nonuniformities can result in degradation in the performance of the coating.

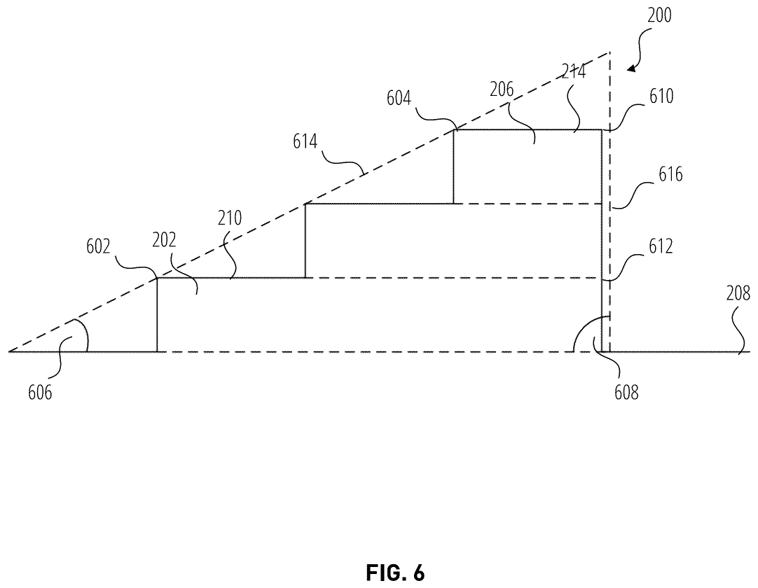

FIG. 6 shows the grating line 200, illustrating the concept of the rising staircase angle and falling staircase angle. As defined herein, the rising staircase angle 606 of a grating line 200 may be regarded as the angle formed between the substrate surface 208 and a line 614 extending through a first end 602 of the upper surface 210 of the bottom layer 202 and a first end 604 of the upper surface 214 of the upper layer 206. As defined herein, the falling staircase angle 608 of a grating line 200 may be regarded as the angle formed between the substrate surface 208 and a line 616 extending through a second end 612 of the upper surface 210 of the bottom layer 202 and a second end 610 of the upper surface 214 of the upper layer 206. (It will be appreciated that, in FIG. 6, the line 616 is shown displaced from the falling staircase side of the grating line 200 for greater visibility, without affecting the falling staircase angle 608.) As used herein, the term “layer edge angle” may refer generally to the angle measured from a top edge of the bottom layer of a stepped side to the top edge of an upper layer of the stepped side, and includes both the rising staircase angle and the falling staircase angle as described above.

In some examples, a rising staircase angle and/or a falling staircase angle may be calculated using different reference points than those described above. For example, an angle may be measured from a lower point on the substrate surface (e.g., a point at the bottom of the bottom layer, or a point horizontally midway between the bottom layers of two adjacent grating lines) to a higher point on the upper surface of the upper layer (e.g., the horizontal midpoint of the upper surface of the upper layer). It will be appreciated that the angles may be measured using any sub combinations of the lower points and upper points described above, and that the rising and falling staircase angles may use different upper and/or lower points in their measurements, in various examples. In some examples, the rising staircase angle and falling staircase angle may be measured by a line passing through horizontal midpoints of two of the treads of the staircase, such as an upper surface of the bottom layer and an upper surface of the upper layer. In some examples, such as examples having steps of a uniform height and width, these measures may result in identical angle values; in other examples, such as examples having nonuniform step heights and/or widths, the choice of angle measurement technique may affect the value of the measured angle. Rising staircase angle values and falling staircase angle values described herein, unless otherwise specified, are calculated as layer edge angles as described above.

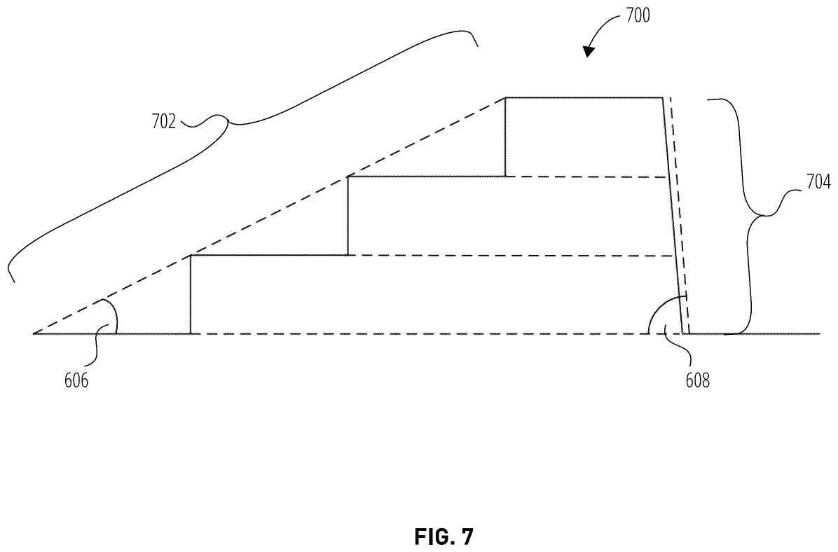

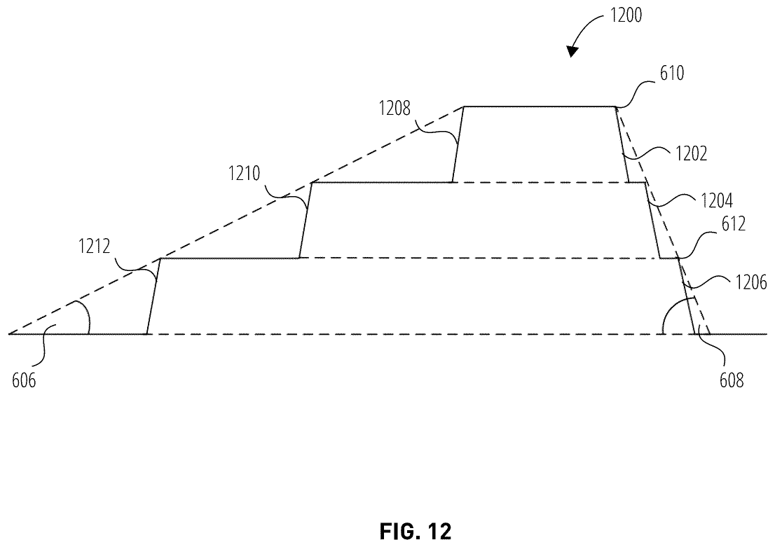

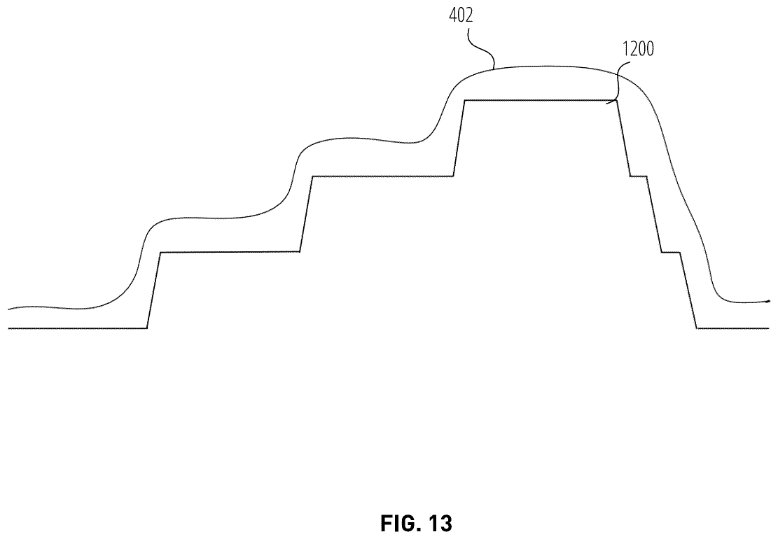

FIG. 7 shows an example grating line 700 having a falling staircase angle 608 less than 90 degrees. As described above, a grating line 700 having a non-perpendicular falling staircase angle 608 may provide a more sloped shape that may address one or more of the technical problems described above.

Whereas the rising staircase portion 702 of the grating line 700 forms a stepped shape in cross-section, the falling staircase portion 704 forms a straight line in cross-section. In some examples, the manufacturing process may result in a straight-line shape of the falling staircase portion even if the working stamp used to imprint the grating line 700 into the moldable material exhibits a stepped shape for the falling staircase portion; this is more likely to be the case for falling staircase angles very close to 90 degrees. Examples of grating lines having sloped faces for one or more layers are described below in reference to FIG. 12 and FIG. 13.

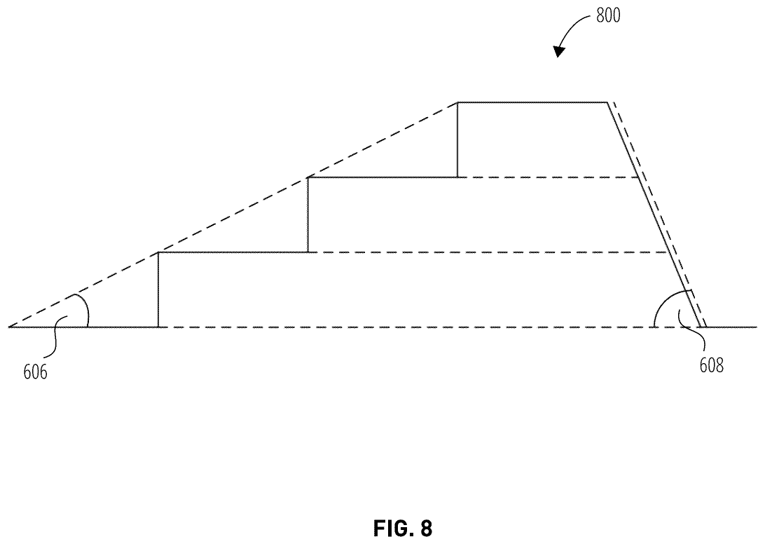

FIG. 8 shows the rising staircase angle 606 and falling staircase angle 608 for a grating line 800 with a straight-line shape for the falling staircase portion. The rising staircase angle 606 is defined by the line passing through the first ends of the upper surfaces of the bottom layer and upper layer, as in FIG. 6. The falling staircase angle 608 is defined, in this example, by the straight line of the falling staircase portion.

The falling staircase angle 608 is approximately 60 degrees in this example grating line 800. In various examples described herein, the falling staircase angle 608 can vary from just under 90 degrees (e.g., 85 degrees) down to as shallow as the rising staircase angle 606. If the rising staircase angle 606 and falling staircase angle 608 are identical, the light may not be properly redirected within the waveguide body, as described below with reference to FIG. 14 through FIG. 16; this effect may be more pronounced the closer the rising staircase angle 606 and falling staircase angle 608 become, placing practical constraints on the shallowness of the falling staircase angle 608 in some examples.

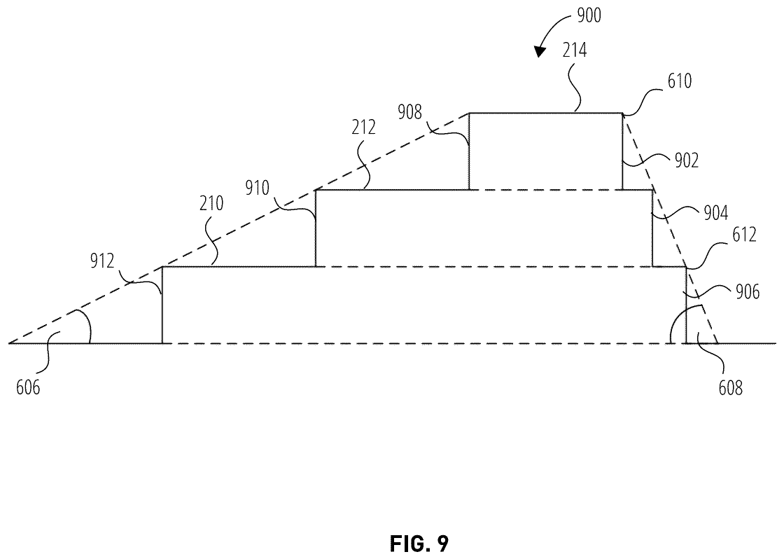

FIG. 9 shows a grating line 900 having stepped shapes for both the rising staircase portion and the falling staircase portion. In this example grating line 900, each layer 202, 204, 206 has a respective rising stair riser 912, 910, 908 (i.e., left face in this illustration) at its first end (i.e., left end in this illustration) that is perpendicular to the substrate surface 208. Furthermore, each layer 202, 204, 206 has a respective falling stair riser 906, 904, 902 (i.e., right face in this illustration) at its second end (i.e., right end in this illustration) that is perpendicular to the substrate surface 208. The rising staircase angle 606 is defined by the tops of the first ends, and the falling staircase angle 608 is defined by the tops of the second ends, e.g., by a line passing through the second end 612 of the upper surface 210 of the bottom layer and through the second end 610 of the upper surface 214 of the upper layer.

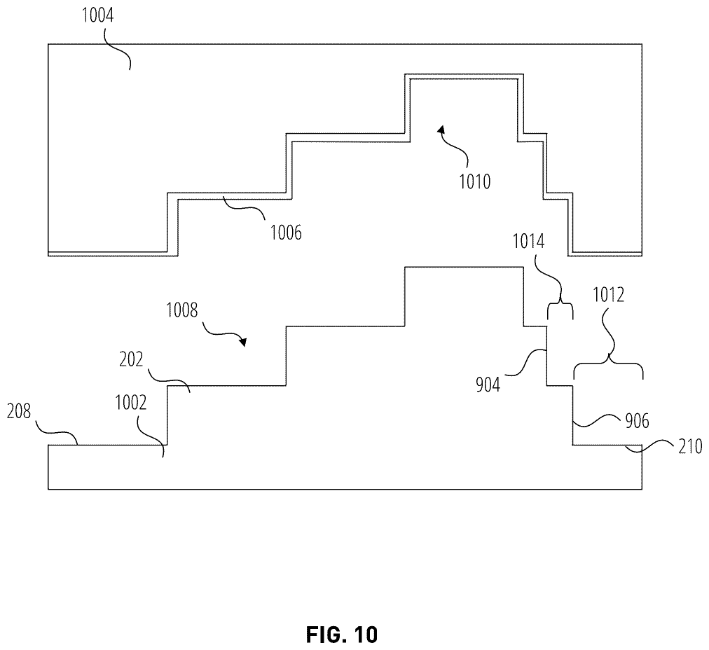

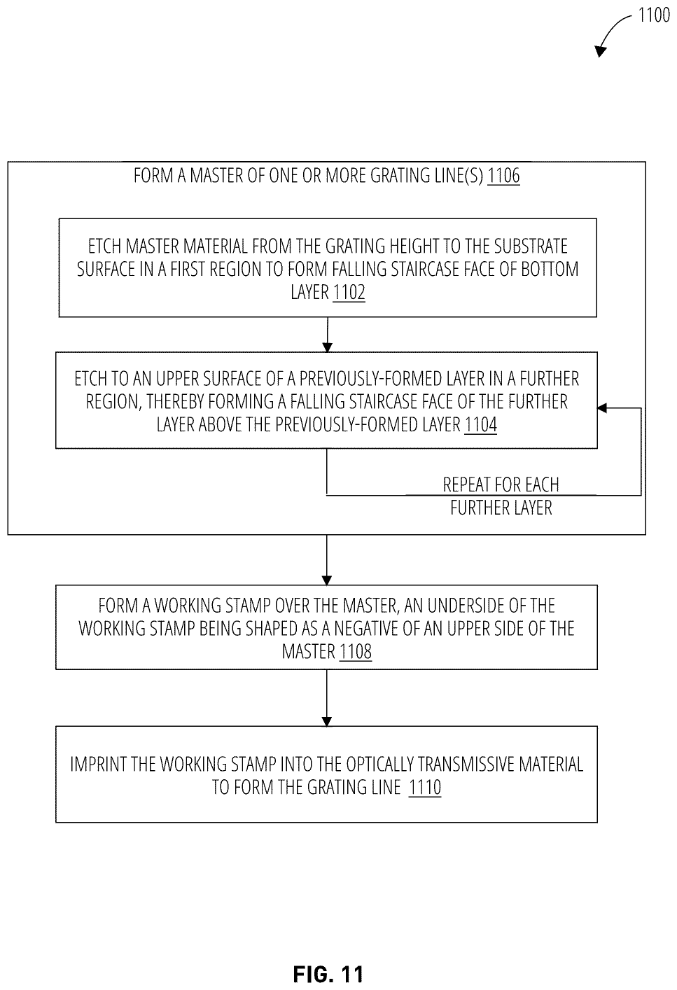

FIG. 10 shows components used in the manufacture of stepped diffraction gratings according to examples described herein. The components shown in FIG. 10 will be described with reference to an example method 1100 shown in the flowchart of FIG. 11.

FIG. 11 illustrates an example method 1100 for manufacturing stepped diffraction gratings having a controlled falling staircase angle. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

At operation 1106, a master of one or more grating line(s) is formed. The master is used to form a mold. It may be, e.g., a hard master or a soft master. Operation 1106 includes sub-steps 1102 and 1104.

A master 1002, as shown in FIG. 10, is a durable structure serving as a positive model of one or more grating lines of the stepped diffraction grating 102. The upper side 1008 of the master 1002 serves as the model for the one or more grating lines. A master 1002 may be formed out of a durable but etchable material, referred to herein as a master material, such as silicon, glass, or quartz in some examples.

At sub-step 1102, the master material is etched to form the gap(s) between adjacent parallel grating lines. The master material is etched from the grating height (i.e., the height above the substrate surface 208 of the upper surface 214 of the upper layer 206) to the substrate surface 208 in a first region 1012 to form the falling stair riser 906 of the bottom layer 202.

After sub-step 1102, the method 1100 repeats sub-step 1104 for each further layer above the bottom layer 202. At sub-step 1104, the master material is etched to the upper surface of the previously-formed layer in a further region, thereby forming a falling staircase face of the further layer above the previously-formed layer. Thus, for example, the first iteration of sub-step 1104 in the example shown in FIG. 10 includes etching in the further region 1014 down to the upper surface 210 of the bottom layer 202, thereby forming the falling stair riser 904 of the intermediate layer.

After the final iteration of sub-step 1104, the method 1100 proceeds to operation 1108. At operation 1108, a working stamp 1004 is formed over the master 1002. As shown in FIG. 10, a working stamp 1004 is a stamp or mold formed over the upper side 1008 of the master 1002, such that an underside 1010 of the working stamp 1004 forms a negative of the upper side 1008 of the master 1002. In some examples, the working stamp 1004 is formed from a moldable material such as a polymer, which is cured or otherwise hardened to hold its shape while it has the upper side 1008 of the master 1002 imprinted into its underside 1010. In some examples, following the hardening of the working stamp 1004, the underside 1010 is covered with a thin layer of a harder material, such as a metal layer 1006. In some examples, the metal layer 1006 is formed from an electroformable metal such as nickel.

After operation 1108, the method 1100 proceeds to operation 1110. At operation 1110, the working stamp 1004 is imprinted into the optically transmissive material to form the grating line 200. In some examples, a layer of the optically transmissive material in a relatively pliable or moldable state, such as a viscous resin, is deposited on top of a substrate (such as a glass substrate) of a waveguide. The working stamp 1004 is then pressed down onto the layer of optically transmissive material to form the grating lines 200 inside the underside 1010 of the working stamp 1004. The optically transmissive material is then cured or otherwise hardened; in some examples, a polymer resin may be cured by passing ultraviolet light upward through the glass substrate and through the layer of optically transmissive material. It will be appreciated that, in some examples, a layer of the optically transmissive material resides between the glass waveguide and the bottom layers of the grating lines 200, such that a top surface of the layer of optically transmissive material constitutes the substrate surface 208. It will also be appreciated that, whereas the entire combined structure of the glass substrate forming the waveguide body 1406 (e.g., in FIG. 14 to FIG. 16) and the stepped diffraction grating (as well as, optionally, a layer of optically transmissive material between them) jointly constitute or operate as a waveguide, in the described examples the glass substrate underlying the stepped diffraction grating (and optionally the layer of optically transmissive material) is referred to as the “waveguide body”.

After the optically transmissive material has hardened, the working stamp 1004 is lifted away from the imprinted shape of the grating lines 200. This operation can present challenges to maintaining the structural integrity of the nanometer-scale grating lines 200, as sharp peaks and perpendicular surfaces may have a tendency to adhere to the inside of the mold formed by the underside 1010 of the working stamp 1004, and may cause parts of the grating line 200 to break off from the rest of the structure or otherwise deform when the working stamp 1004 is lifted away. Similarly, certain shapes may have a tendency to imperfectly fill out the shape of the underside 1010 of the working stamp 1004, and/or to deform when the working stamp 1004 is lifted away. FIG. 12 and FIG. 13 present examples of typical shapes of grating lines formed by these fabrication techniques.

For the sake of clarity and simplicity, a master 1002 and working stamp 1004 in the shape of a single grating line are shown in FIG. 10. However, it will be appreciated that, in some examples, the master 1002 and/or working stamp 1004 are fabricated to encompass many or all grating lines of the stepped diffraction grating 102, and the operations of method 1100 are performed for an entire section of the stepped diffraction grating 102, or the entire stepped diffraction grating 102, at a time.

FIG. 12 shows an example of a grating line 1200 formed through fabrication techniques such as the example method 1100. Even if a working stamp 1004 is used that has perpendicular faces for the various layers 202, 204, 206, in practice the imperfections introduced by imprinting tend to result in layers that have rising stair risers 1208, 1210, 1212 and falling stair risers 1202, 1204, 1206 having a sloped shape in cross-section, such that each falling stair riser 1202, 1204, 1206 forms a layer edge angle with the substrate surface between the falling staircase angle and 90 degrees. In some examples, if the falling staircase angle 608 is close to 90 degrees and the degree of slope introduced to the falling stair risers 1202, 1204, 1206 by the imprinting process is high enough, the falling staircase portion of the grating line can resemble a straight line, as shown in the grating line 700 of FIG. 7 or the grating line 800 of FIG. 8, in which the layer edge angle is equal or essentially equal to the falling staircase angle.

In some examples, the shape of the grating line 1200 is intentionally sloped, rather than being sloped as a result of imperfections in the imprinting process. A working stamp 1004 having sloped faces instead of perpendicular faces may be used to form the grating line 1200 at operation 1110. Lifting such a working stamp 1004 away may result in less risk of breakage or deformation of portions of the grating line 1200 due to the sloped faces having a decreased tendency to adhere to the underside 1010 of the working stamp 1004 and the greater degree of freedom for the angle at which the working stamp 1004 is lifted away from the cured optically transmissive material.

FIG. 13 shows the grating line 1200 of FIG. 12 covered by a coating 402, such as a reflective coating of TiO₂ or another reflective material or a multilayer stack of materials as described above in reference to FIG. 4 and FIG. 5. In the example of FIG. 13, the coating 402 is deposited relatively uniformly over the grating line 1200, generally avoiding the nonuniformities shown in FIG. 5. The uniformity of the coating 402 may be assisted, in some examples, by the generally sloped sides of the grating line 1200, due to the lack of acute concave corners and perpendicular surfaces.

FIG. 14 shows the operation of an example input grating 1402, implemented as a stepped diffraction grating 102 according to examples described herein, as an input grating to a waveguide body 1406. The example components shown in FIG. 14 through FIG. 16 may operate as part of an optical assembly, such as an augmented reality display or other device that projects light into a waveguide body 1406 using an exit pupil 1410 of a light engine and an input grating 1402. The goal of the device is to couple the projected light into the waveguide body 1406 such that the light is propagated down the length of the waveguide body 1406 through total internal reflection (TIR). If the light fails to couple into the waveguide body 1406 (i.e., a low in-coupling efficiency is realized), and/or if the light is back-coupled out of the waveguide back through the exit pupil 1410 of the light engine (i.e., a high back-coupling efficiency is realized), this can decrease the overall efficiency of the device and/or create spurious reflections which may result in ghost images or other undesirable artifacts. Thus, it may be desirable for the configuration of the components shown in FIG. 14 to realize a high in-coupling efficiency and a low back-coupling efficiency.

The components shown in FIG. 14 through FIG. 16 are described in spatial terms with reference to their positions in the figures, e.g., “down” refers to the direction toward the bottom of the figure. However, it will be appreciated that the components can be oriented arbitrarily with respect to a given environment, and are shown in FIG. 14 through FIG. 16 in a side cross-sectional view such that the waveguide body 1406 has a waveguide thickness 1408 within which TIR may be realized. Similarly, the input grating 1402 is positioned on an upper surface of the waveguide body 1406 (in this case, the surface of the waveguide body 1406 opposite the exit pupil 1410) and the exit pupil 1410 of the light engine is positioned at a light engine standoff 1418 from a lower surface of the waveguide body 1406 (in this case, the surface of the waveguide body 1406 opposite the input grating 1402). The input grating 1402 has an input grating diameter 1404 (assuming a circular input grating) shown as a width of the input grating 1402 along the length of the waveguide body 1406, defining a centerline 1420. The exit pupil 1410 has an exit pupil diameter 1414 (assuming a circular exit pupil 1410) shown as a width of the exit pupil 1410 along the length of the waveguide body 1406, defining a centerline 1422. The centerlines 1420, 1422 of the input grating 1402 and exit pupil 1410 are offset by a light engine offset 1416. The specific shapes, spacings, and dimensions of the various components illustrated and described herein are intended merely as examples.

It will also be appreciated that the input grating 1402 is not shown to scale in FIG. 14 through FIG. 16, but is instead shown in a stylized rendering. In some examples, the input grating 1402 is multiple orders of magnitude thinner than the waveguide body 1406: for example, the height of the input grating 1402 (including the height of each grating line as well as the thickness of underlying layer of optically transmissive material serving as substrate surface 208) may be less than 500 nanometers, whereas the waveguide thickness 1408 may be in excess of 500 micrometers. Thus, the illustration of light diffracting from the input grating 1402 is shown as occurring at the interface of the waveguide body 1406 and the input grating 1402 due to the invisible thinness of the actual input grating 1402 when drawn to scale. Moreover, the length and width of the waveguide are greater than the size of the input grating, e.g., the diameter 1404 of the circular input grating 1402. Furthermore, it will be appreciated that whereas the stylized rendering of the input grating 1402 shows grating lines that are triangular in cross-section with a falling staircase angle of 90 degrees, the principles illustrated by FIG. 14 through FIG. 16 are applicable to any configuration of the input grating 1402, including examples described herein having a falling staircase angle of less than 90 degrees.

The light engine (not shown) may include a projector or other light source, projecting a beam of light at or through the light engine's exit pupil 1410. The light engine exit pupil 1410 is not shown to scale in FIG. 14 through FIG. 16 relative to the waveguide 1406 and the input grating 1402, and is instead shown in stylized rendering. Light propagation from the light engine to the waveguide and within the waveguide is illustrated by rays. For convenience, the light engine exit pupil 1410 is split into infinitesimally small parts, of which location 1412 is an example, to describe the light paths from the light engine exit pupil to the waveguide and within the waveguide. A portion of the light projected from the light engine passes through a light exit location 1412 of the exit pupil 1410 of the light engine as ray 1424. Ray 1424 strikes the bottom surface of the waveguide body 1406 at an incident angle 1426 from the vertical (i.e., in this example, a surface normal of the bottom surface of the waveguide body 1406). As the light enters the waveguide body 1406, it is refracted into ray 1430 at waveguide refraction angle 1428 from the vertical. It will be appreciated that the light paths from different exit locations within the light engine's exit pupil can be traced similarly.

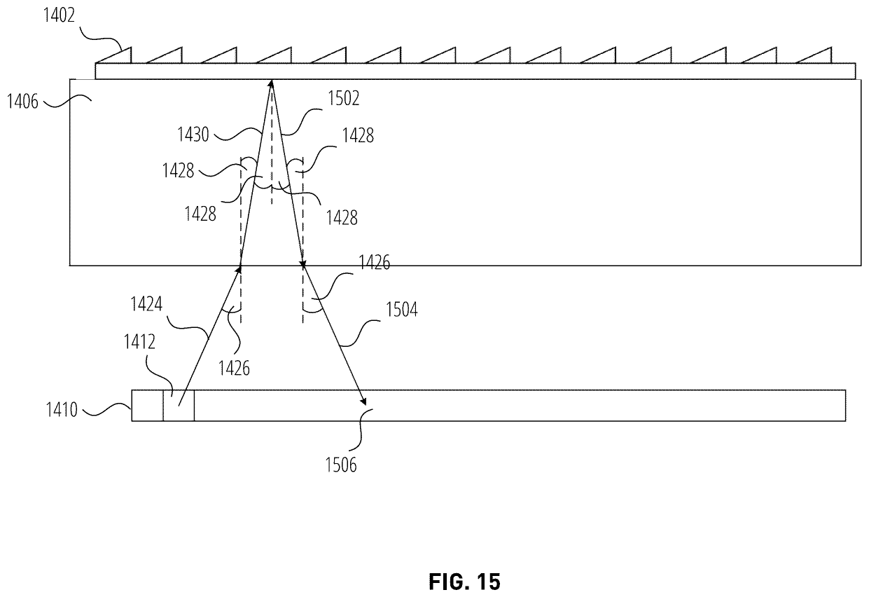

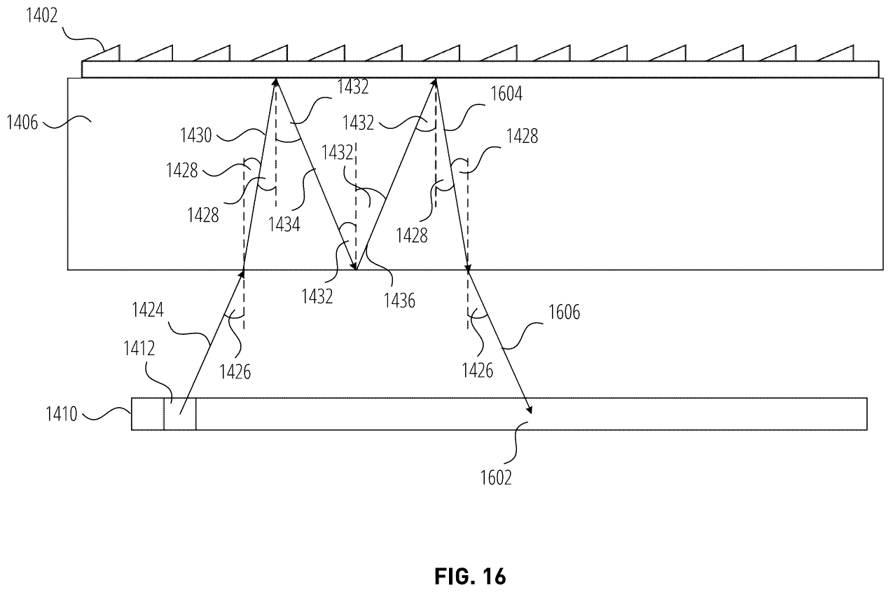

Ray 1430 then interacts with the input grating 1402 at an incident angle which is equal to waveguide refraction angle 1428. The design of the input grating 1402, including its geometry and properties, will affect the tendency of the ray 1430 of light to diffract back into the waveguide body 1406 in different directions. In particular, changes to the falling staircase angle of the grating lines of the input grating can affect the amount of light diffracting in various directions, as described below with reference to FIG. 15 and FIG. 16 and in the section below on DESIGN. It is noted that in this example the waveguide geometry and input grating design are selected so that the input grating operates in reflection. Other waveguide geometries arc feasible with the input grating operating in transmission.

In the ideal case, all of the light is diffracted from the input grating at the intended angle based on the design of the input grating 1402, shown as the first angle 1432 of diffracted ray 1434. In practice, the light is diffracted into multiple orders from the input grating 1402, and ray 1434 represents the first-order diffraction, with the highest diffracted power and contributing to the in-coupling efficiency in this example. Ray 1434 then contacts the bottom surface of the waveguide body 1406 at first angle 1432, which is a sufficient angle to result in total internal reflection, such that the light reflects again as ray 1436, again at first angle 1432 to the bottom surface of the waveguide body 1406. Ray 1436 travels toward the top surface of the waveguide, and it is incident on the input grating 1402 at the same first angle 1432 such that the light reinteracts with the input grating 1402 and diffracts into multiple orders. In the ideal case, the zero-order ray 1438, which is diffracted at the first angle 1432, carries most of the optical power, and it propagates toward the bottom surface of the waveguide from which it is reflected by TIR at first angle 1432. In the ideal case, the light continues along the length of the waveguide at first angle 1432 at each zero-order diffraction of ray 1436 at the input grating 1402, TIR of ray 1438 at the bottom surface, zero-order diffraction of ray 1440 at the input grating 1402, TIR of ray 1442 at the bottom surface, and so on. It will be appreciated that at some position along the length of the waveguide, the TIR ray from the bottom surface of the waveguide will be incident at the top surface of the waveguide where the input grating is no longer present due to the smaller size of the input grating relative to the length and width of the waveguide. The ray will then travel up and down the waveguide toward the right in FIG. 14 via TIR at the top and bottom surfaces of the waveguide. The overall in-coupling efficiency for a given incident angle 1426 from the light engine exit pupil 1410 is determined by considering the multiple paths of light from all the infinitesimal elements (e.g., each light exit location 1412) of the light engine exit pupil 1410 at incident angle 1426, including any reinteractions with the input grating 1402, as described above. The number of reinteractions with the input grating 1402 will depend on the ray path from the light engine exit pupil 1410 and its incident angle at the bottom surface of the waveguide, in addition to the geometry of the input grating relative to the light engine exit pupil size and the geometry of the waveguide. A similar approach as described herein can be applied to determine the overall in-coupling efficiency as a function of incident angle from the light engine exit pupil 1410 over the field of view.

Thus, FIG. 14 illustrates an ideal case in which the projected light from the light engine is coupled into the waveguide body 1406 and undergoes diffraction and/or TIR to propagate down the length of the waveguide body 1406 in a light propagation direction 1444 until it reaches a further optical component intended to redirect it elsewhere, such as an output grating, a reflector, or simply an output end of the waveguide. In some examples, the in-coupling efficiency of the configuration shown in FIG. 14 may be affected by factors such as the wavelength of the projected light and the incident angle 1426. However, the case shown in FIG. 14 is taken to be the ideal case with respect to back-coupling of the light out of the waveguide after it enters. In contrast, FIG. 15 and FIG. 16 illustrate examples in which this ideal case is not achieved.

FIG. 15 shows the cross-sectional view of the configuration of FIG. 14, showing light entering and reflecting out of the waveguide body 1406 along a first back-coupling path. FIG. 15 thus illustrates a non-ideal case resulting in a portion of the projected light back-coupling out of the waveguide body 1406 back toward the exit pupil 1410, which can result in not only loss of a portion of the projected light but also potentially further spurious reflections off portions of the light engine back into the waveguide body 1406, which can generate interference, ghost images offset from the intended image (and potentially mirrored from the intended orientation of the image), and/or other visual artifacts.

The projected light follows the same initial path as the light in FIG. 14. For example, light projected from the light engine passes through the light exit location 1412 of the exit pupil 1410 of the light engine as ray 1424. Ray 1424 strikes the bottom surface of the waveguide body 1406 at the incident angle 1426. As the light enters the waveguide body 1406, it is refracted into ray 1430 at waveguide refraction angle 1428.

Ray 1430 then interacts with the input grating 1402, as described in relation to FIG. 14. A portion of the light is diffracted into the zero-order as ray 1502 at an unintended angle, namely the same waveguide refraction angle 1428 as ray 1430, while the rest of the light diffracts into other orders, including the one illustrated by ray 1434 in FIG. 14.

Because ray 1502 intersects the bottom surface of the waveguide body 1406 at waveguide refraction angle 1428, it does not undergo TIR, and is instead back-coupled out of the waveguide body 1406 toward the exit pupil 1410 as ray 1504 at a refracted angle (equal to incident angle 1426 in this example) in the medium outside the waveguide. Ray 1502 thus represents light that is lost from the waveguide body 1406 and unavailable to form the intended image. Furthermore, ray 1504 may overlap the exit pupil 1410 at first return path location 1506, potentially traveling toward the light engine and reflecting back toward the waveguide body 1406 and potentially being re-coupled back into the waveguide body 1406 at a different location from its intended location. A fraction of the light from various pixels of the image projected by the light engine may thus follow the first back-coupling path shown in FIG. 15, reflect off of the light engine (or another component), and re-couple into the waveguide inverted into a mirror image of the intended image, at a different location from the light following the desired case path of FIG. 14. This can result in a “ghost image”, mirrored and offset from the intended location, at an output of the waveguide body 1406. Thus, it may be desirable to reduce the amount of light following the first back-coupling path by adjusting the structure of the grating lines of the input grating 1402.

Various factors, including details of the structure of each grating line of the input grating 1402, can affect the likelihood of light being diffracted from the input grating 1402 at waveguide refraction angle 1428 instead of first angle 1432 when striking the input grating 1402 at the waveguide refraction angle 1428. Technical work, as described below in the section on DESIGN, indicates that changes to the structure of the grating lines (and in particular, changes to the falling staircase angle) can affect the amount of light reflected along the first back-coupling path shown in FIG. 15, i.e., its contribution to the back-coupling efficiency. The overall back-coupling efficiency for this first back-coupling path at a given incident angle 1426 from the light engine exit pupil 1410 is determined by considering the paths of light from all the infinitesimal elements of the light engine exit pupil 1410 at incident angle 1426. A similar approach as described herein can be applied to determine the overall back-coupling efficiency for this first back-coupling path as a function of incident angle from the light engine exit pupil 1410 over the field of view.

FIG. 16 shows the cross-sectional view of the configuration of FIG. 14 and FIG. 15, showing light entering and reflecting out of the waveguide body 1406 along a second back-coupling path. FIG. 16 thus illustrates another non-ideal case resulting in a portion of the projected light back-coupling out of the waveguide body 1406. Whereas the first back-coupling path of FIG. 15 can be considered a non-ideal case caused by zero-order diffraction by the input grating, the second back-coupling path of FIG. 16 can be considered a non-ideal case caused by a positive first-order diffracted ray from the input grating 1402 and a subsequent reinteraction of the light with the input grating 1402 resulting in a negative first-order diffracted ray at a different location of the input grating 1402.

In FIG. 16, the projected light follows the same initial path as the light in FIG. 14 and FIG. 15. A portion of the light projected from the light engine passes through the light exit location 1412 of the exit pupil 1410 of the light engine as ray 1424. Ray 1424 strikes the bottom surface of the waveguide body 1406 at the incident angle 1426. As the light enters the waveguide body 1406, it is refracted into ray 1430 at waveguide refraction angle 1428.

Ray 1430 then interacts with the input grating 1402. A fraction of the light is initially diffracted as ray 1434, which is the positive first order, at the intended first angle 1432, as in FIG. 14. Ray 1434 reflects via TIR from the bottom surface of the waveguide body 1406 as ray 1436, again at first angle 1432.

Ray 1436 is incident on the input grating 1402 at first angle 1432, and it diffracts into multiple orders, including ray 1604, which is the negative first order. Ray 1604 has the same unintended angle as the zero-order diffracted ray 1502 of FIG. 15, namely waveguide refraction angle 1428. This results in back-coupling of the diffracted ray 1604 out of the waveguide body 1406, thereby refracting into ray 1606 at a refracted angle (incident angle 1426 in the illustrated example) in the medium outside the waveguide to overlap the exit pupil 1410 at second return path location 1602. The back-coupling efficiency for this second light path indicates how much of the projected light follows the second back-coupling path of FIG. 16; it may be desirable to reduce the back-coupling efficiency for this second path for the same reasons as reducing the back-coupling efficiency for the first path in FIG. 15, e.g., reducing the amount of light lost to back-coupling and reducing the prevalence of ghost images due to this second back-coupling path (in addition to the ghost images caused by the first back-coupling path of FIG. 15). The overall back-coupling efficiency for this second back-coupling path at a given incident angle 1426 from the light engine's exit pupil 1410 is determined by considering the path of light from all the infinitesimal elements of the light engine exit pupil 1410 at incident angle 1426. A similar approach as described herein can be applied to determine the overall back-coupling efficiency for this second back-coupling path as a function of incident angle from the light engine exit pupil 1410 over the field of view.

It will be appreciated that the back-coupling paths shown in FIG. 15 and FIG. 16 constitute a subset of the possible back-coupling paths. Other back-coupling paths, involving different combinations of diffracted orders resulting from reinteractions of the light with the input grating 1402 may also contribute to the back-coupling efficiency. The efficiency of various back-coupling paths may be affected by factors such as the specific angles achieved by the optical assembly, the dimensions and spacing of the waveguide body 1406 and other components, the wavelengths of light being propagated, the diameters of the input grating 1402 and exit pupil 1410, and so on.

### Design

The behavior of various input grating structures has been modeled in order to determine how different falling staircase angles of a stepped grating line structure affect in-coupling and back-coupling efficiencies of an optical assembly as shown in FIG. 14 through FIG. 16, with respect to various wavelengths of light. In an embodiment of the present invention, simulations were performed for light at three different wavelengths [blue (B) light at 470 nm, green (G) light at 530 nm, and red (R) light at 620 nm] entering the waveguide body 1406 at various incident angles 1426 (from-12 degrees to 12 degrees), and using an input grating 1402 having grating line falling staircase angles between 90 degrees and 60 degrees.

The modeled optical assembly had the following characteristics:

TABLE 1
Simulation Parameters

| Parameter | Specification | |
|---|---|---|
| Type of input grating 1402 | Stepped grating | |
| Projected light wavelengths | 470 nm, 530 nm, 620 nm | |
| Material of waveguide body 1406 | Glass | |
| Optically transmissive material | Optically transparent resin | |
| Coating material | TiO₂ (single layer) | |
| Grating period | 390 | nm |
| Waveguide thickness 1408 | 0.7 | mm |
| Number of layers | 3 | |
| Width of rising staircase treads | [97 nm, 98 nm, 98 nm] | |
| (bottom to upper layer) | | |
| Thickness of layers (bottom to | [50 nm, 40 nm, 40 nm] | |
| upper layer) | | |
| TiO₂ thickness | 50 | nm |
| Rising staircase angle | 22.2° (from top left of bottom | |
| | layer to top left of upper layer) | |
| Falling staircase angle | 90°-60° | |
| Field of view (FOV) | 24° (−12° to 12°) | |
| Light engine exit pupil | 4 | mm |
| diameter 1414 | | |
| Input grating diameter 1404 | 5 | mm |
| Light engine standoff 1418 | 1.5 | mm |
| Light engine offset 1416 | 0 | mm |

Different figures of merit (FOMs) are used to quantify the performance of the optical assembly described above: (a) the in-coupling efficiency as a function of wavelength and incident angle, (b) the combined back-coupling efficiency, defined as the sum of the back-coupling efficiencies due to multiple back-coupling paths, as a function of wavelength and incident angle, (c) FOM1, and (d) FOM2. FOM1 and FOM2 consider the combined effect of all wavelengths and incident angles within the FOV. FOM1 refers to the effective in-coupling efficiency obtained by summing the in-coupling efficiencies over the wavelengths and incident angles and normalized by the number of wavelengths and incident angles used in the simulations. FOM2 is defined as the ratio of the effective in-coupling efficiency to the effective combined back-coupling efficiency due to multiple back-coupling paths, summed over the wavelengths and incident angles. FOM1 and FOM2 are useful metrics to assess the overall performance of the designed optical assembly.

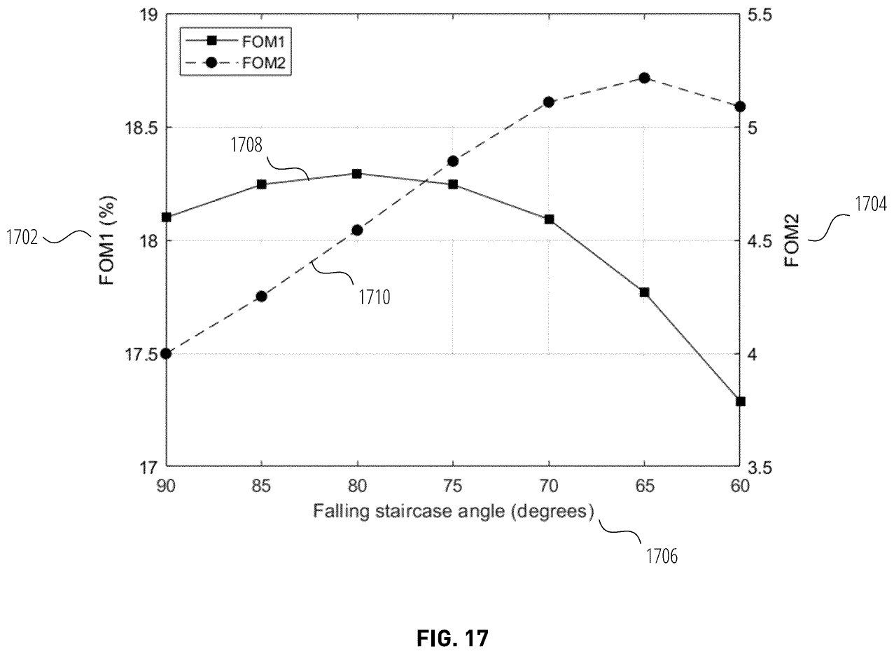

FIG. 17 shows the latter two figures of merit, FOM1 and FOM2, graphed against the falling staircase angle as tested in the simulation. As the falling staircase angle axis 1706 extends from 90 degrees at the left to 60 degrees at the right, it can be seen that FOM2 1710 (mapped to FOM2 axis 1704) peaks at 65 degrees, whereas FOM1 1708 does not change substantially.

The results of the simulations indicate several findings of note related to changes in the falling staircase angle of the grating lines of the input grating 1402. First, decreasing the falling staircase angle from 90 degrees leads to a small change in in-coupling efficiency, but this effect is modest across all simulated light wavelengths and angles of incidence for falling staircase angles of 90 to 60 degrees. This is reflected in the relatively flat variation of FOM1 1708 with falling staircase angle in the 90 to 60 degree range. Second, decreasing the falling staircase angle leads to a decrease in combined back-coupling efficiency, which is illustrated by an enhancement of FOM2 1710 by 30% with about 2% decrease in FOM1 1708.

In some examples, the stepped diffraction grating has grating lines that vary in their falling staircase angle and/or their rising staircase angle in different regions of the stepped diffraction grating. For example, if light generally propagates through the waveguide body 1406 from an input region (e.g., a region occupied by an input diffraction grating) toward one or more output regions (e.g., regions occupied by output diffraction gratings), the intensity of the light may tend to diminish as it travels along a light propagation path from the input region to an output region, and this may mean that increased in-coupling efficiency (as represented by, e.g., FOM1 1708) becomes more important than decreased back-coupling efficiency (as represented by, e.g., FOM2 1710) as the light recedes from the input region and approaches the output region. Based on the simulation results described above, in the context of the example simulation parameters set out in Table I above, a falling staircase angle close to 80 degrees may be associated with a very slight increase in-coupling efficiency, whereas a falling staircase angle of approximately 65 degrees may be associated with a favorable ratio of in-coupling efficiency to back-coupling efficiency. Thus, in some examples, the stepped diffraction grating is configured to propagate light along a light propagation path beginning at a first region (e.g., a region closer to the input region) and ending at a second region (e.g., a region closer to an output region), and the parallel grating lines have a first falling staircase angle in the first region and a second falling staircase angle in the second region, the first falling staircase angle being closer to 90 degrees than the second falling staircase angle. For example, a stepped diffraction grating may have grating lines having a 90 degree angle in a first region near the input region, and a 60 degree angle in a second region near an output region.

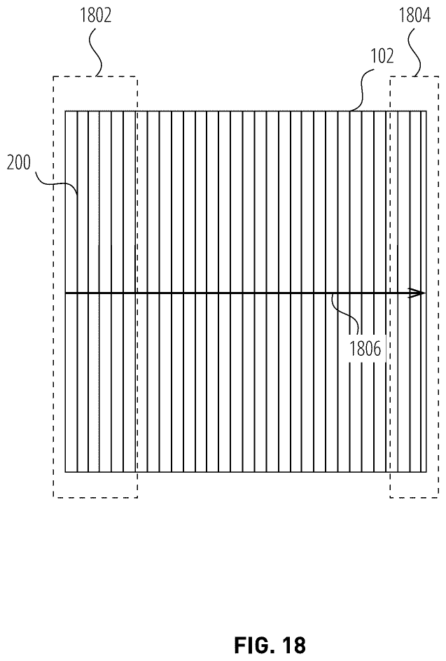

FIG. 18 illustrates the stepped diffraction grating 102 of FIG. 1, having parallel grating lines 200 configured to propagate light along a first light propagation path 1806. The first light propagation path 1806 may correspond generally to light propagation direction 1444 shown in FIG. 14. Whereas the actual path travelled by the light is a zig-zag path defined by the total internal reflections described in reference to FIG. 14 through FIG. 16 above, the light propagation direction 1444 and first light propagation path 1806 indicate the overall direction travelled by the light within the waveguide body 1406.

In some examples, the gap defined between two adjacent grating lines of the stepped diffraction grating is of a generally constant width. In other examples, this gap may change in width between different regions of the stepped diffraction grating, or may change (e.g., continuously) within a region or across the area of the stepped diffraction grating (e.g., changing over light propagation direction 1444). In some examples, the width of the gap may change in accordance with the change in the falling staircase angle: for example, as the falling staircase angle decreases, this may result in the falling staircase portion of each grating line extending farther (e.g., to the right in the examples shown in the drawings), and the gap between grating lines may be narrowed correspondingly in order to preserve a constant period for the stepped diffraction grating. Thus, for example, a period defined by the width of the gap plus the width of a grating line may remain constant, and grating lines having a lower falling staircase angle may be wider than grating lines having a higher falling staircase angle may be narrower.

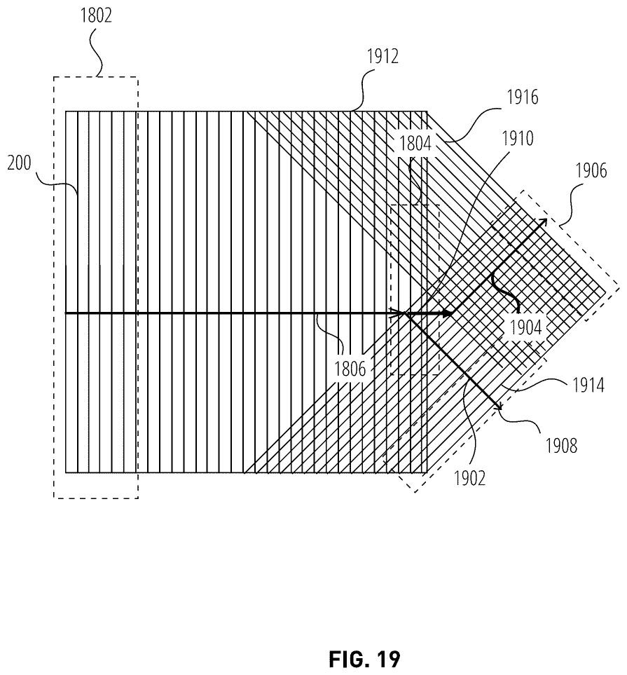

FIG. 19 illustrates a stepped diffraction grating 1912 having multiple sets of parallel grating lines configured to propagate light along multiple light propagation paths. In a first region 1802 near the input (e.g., the first region may define or may be near an input optical diffraction grating), the grating lines 200 have a first falling staircase angle (e.g., 90 degrees). As the light propagates along first light propagation path 1806 perpendicular to the grating lines 200, the falling staircase angle may decrease continuously, or the falling staircase angle may be constant until a new region is reached.

At the end of first light propagation path 1806, in second region 1804, a second set of grating lines 1914 is encountered by the light, causing the light to split into a second light propagation path 1910 perpendicular to the first set of grating lines 200 and a third light propagation path 1902 perpendicular to the second set of grating lines 1914. The second light propagation path 1910 eventually passes out of second region 1804 and encounters a third set of grating lines 1916, causing the light to split again, with a portion of the light following a fourth light propagation path 1904 toward a fourth region 1906. The third light propagation path 1902 eventually reaches a third region 1908.

Thus, the overlapping sets of grating lines shown in FIG. 19 generate multiple light propagation paths for light travelling from the first region 1802: each individual light propagation path 1806, 1910, 1902, 1904; the path along first light propagation path 1806 and third light propagation path 1902; the path along first light propagation path 1806 and second light propagation path 1910; the path along first light propagation path 1806, second light propagation path 1910, and fourth light propagation path 1904; and the path along second light propagation path 1910 and fourth light propagation path 1904. In each such case, the light may travel from one region to another region more distant from the input (e.g., from first region 1802 to second region 1804, from first region 1802 to fourth region 1906, from second region 1804 to third region 1908, and so on), and the falling staircase angle of the grating lines in the two regions may differ such that the region closer to the input has grating lines with a falling staircase angle closer to 90 degrees (e.g., 80 degrees or 90 degrees) than the grating lines in the region farther from the input (e.g., 60 degrees).

In general, the reduction in back-coupling efficiency caused by decreased falling staircase angle is more pronounced for blue and green light than for red light, with the change in back-coupling efficiency in red being relatively negligible. Specifically, the simulated blue light (470-nm wavelength) and green light (530-nm) exhibit a minimum combined back-coupling efficiency at a falling staircase angle of about 60 degrees. Furthermore, the reduction in combined back-coupling efficiency for an decreased falling staircase angle is substantial relative to the baseline of a 90-degree falling staircase angle: in the optimal case, FOM2 1710 increases by 30% while FOM1 1708 remains fairly constant (varying only by 2%), showing a significant decrease in the effective back-coupling efficiency relative to the effective in-coupling efficiency.

It will be appreciated that falling staircase angles smaller than the rising staircase angle of a grating line will tend to reverse the direction travelled down the length of the waveguide by the reflected light. When the falling staircase angle is smaller than the rising staircase angle, the falling staircase portion acts as the rising staircase portion instead, and the input grating sends the majority of the light toward the wrong end of the waveguide. Furthermore, a certain degree of this behavior is seen as the falling staircase angle approaches the rising staircase angle, as can be inferred from the simulation results suggesting a continued decrease in in-coupling efficiency with decreased falling staircase angle beyond 60 degrees. Thus, it may be beneficial to select a falling staircase angle that does not unduly decrease in-coupling efficiency but does decrease combined back-coupling efficiency.

Specific falling staircase angles can thus be selected for the design of input gratings for waveguides based on factors such as the rising staircase angle, the incident angle of light projected from a light engine, and the wavelength of the projected light. In a general case of a rising staircase angle between 10 degrees and 45 degrees, a falling staircase angle of 65° may be selected, thereby reducing combined back-coupling efficiency without a significant decrease in in-coupling efficiency. Alternatively, a falling staircase angle of 80° may be selected to achieve a smaller reduction in back-coupling efficiency, while maximizing in-coupling efficiency. These results can be expected to apply, with suitable modifications, across various ranges of rising staircase angle values, such as being at least partially applicable for rising staircase angles of 10 degrees to 60 degrees, and being highly applicable to rising staircase angles of 20 degrees to 25 degrees.

Example stepped diffraction gratings described herein may be formed using grating lines of uniform dimensions across the stepped diffraction grating, or grating lines of different dimensions across different portions of the stepped diffraction grating. For example, the falling staircase angle can be modulated across the width of a stepped diffraction grating such that the grating lines at a near end of the stepped diffraction grating operate according to a first set of optical parameters, but the grating lines at a far end of the stepped diffraction grating operate according to a second set of optical parameters. Modulation across different portions of the stepped diffraction grating may be beneficial in some examples, for example if portions of the light are coupled out of the waveguide over the width of the stepped diffraction grating, thereby requiring greater out-coupling efficiency at the far end than at the near end to achieve uniformity in light emitted (i.e., out-coupled) from the waveguide.

In some examples, the stepped diffraction grating may include diffractive elements that are not formed as parallel lines, but are instead formed using different structures that have cross-sectional shapes, through a plane parallel to the direction of light propagation, as described herein (e.g., defining a rising staircase and a falling staircase).

### CONCLUSION

As described above, examples described herein may address one or more technical problems associated with stepped diffraction gratings. Deformation of the grating line during manufacture may be reduced due to the more gradual slope of the sides of the grating line. The uniformity of a coating can be improved and/or convexities in the coating may be reduced or eliminated by the sloped shape of the grating line. Finally, the amount of light back-coupling out of the waveguide may be reduced for some wavelengths of light, for some falling staircase angles.

Thus, in accordance with various examples described herein, stepped diffraction gratings have grating lines with falling staircase angles of less than 90 degrees, and methods for the manufacture thereof, are provided.

Example 1 is a method for manufacturing a stepped diffraction grating, comprising: forming a plurality of parallel grating lines on a substrate surface, each grating line formed by: forming a plurality of stacked layers of optically transmissive material extending away from the substrate surface such that, in cross-section within a plane normal to the parallel grating lines, each grating line comprises: an upper layer having an upper surface at a grating height away from the substrate surface, the upper layer having a first end and a second end; a bottom layer having: a bottom surface abutting the substrate surface; and an upper surface having a first end and a second end; a rising staircase portion extending from the first end of the upper surface of the upper layer to the first end of the upper surface of the bottom layer at a rising staircase angle, defined relative to the substrate surface, between 10 degrees and 60 degrees; and a falling staircase portion extending from the second end of the upper surface of the upper layer to the second end of the upper surface of the bottom layer at a falling staircase angle, defined relative to the substrate surface, that is greater than the rising staircase angle and less than 80 degrees.

In Example 2, the subject matter of Example 1 includes, wherein: forming each grating line further comprises: forming a master of the grating line by: etching a master material from the grating height to the substrate surface in a first region, thereby forming a falling staircase face of the bottom layer extending to the substrate surface from the second end of the upper surface of the bottom layer; and repeating, for each of one or more further layers including the upper layer: etching the master material to an upper surface of a previously-formed layer in a further region, thereby forming a falling staircase face of the further layer above the previously-formed layer; forming a working stamp over the master, an underside of the working stamp being shaped as a negative of an upper side of the master; and imprinting the working stamp into the optically transmissive material to form the grating line.

In Example 3, the subject matter of Example 2 includes, after forming the working stamp: forming a metal layer on an underside of the working stamp.

In Example 4, the subject matter of Examples 2-3 includes, wherein: the falling staircase face of each layer defines, in cross-section within the plane, a layer edge angle with the substrate surface that is greater than the falling staircase angle and less than 90 degrees.

In Example 5, the subject matter of Examples 1-4 includes, wherein forming each grating line further comprises, after forming the plurality of stacked layers: depositing a coating on the grating line.

In Example 6, the subject matter of Example 5 includes, wherein: the coating comprises a material having a high refractive index.

In Example 7, the subject matter of Example 6 includes, wherein: the material having the high refractive index comprises titanium dioxide (TiO2).

In Example 8, the subject matter of Examples 1-7 includes, wherein: the optically transmissive material comprises a transparent or partially transparent resin.

In Example 9, the subject matter of Examples 1-8 includes, wherein: the substrate surface is an upper surface of a waveguide body.

In Example 10, the subject matter of Examples 1-9 includes, wherein: the rising staircase angle is between 15 degrees and 45 degrees.

In Example 11, the subject matter of Examples 1-10 includes, wherein: the rising staircase angle is between 14 degrees and 30 degrees.

In Example 12, the subject matter of Examples 1-11 includes, wherein: the rising staircase angle is between 20 degrees and 25 degrees.

In Example 13, the subject matter of Examples 1-12 includes, wherein: the falling staircase angle is between 60 degrees and 89 degrees.

In Example 14, the subject matter of Examples 1-13 includes, wherein: the falling staircase angle is between 60 degrees and 70 degrees.

In Example 15, the subject matter of Examples 1-14 includes, wherein: the falling staircase angle is 65 degrees.

In Example 16, the subject matter of Examples 1-15 includes, wherein: the falling staircase angle is 80 degrees.

In Example 17, the subject matter of Examples 1-16 includes, wherein: the grating height is between 50 nm and 250 nm.

In Example 18, the subject matter of Example 17 includes, wherein: the stepped diffraction grating further comprises, between each adjacent pair of grating lines, a gap having a width between 10 nm and 130 nm.

In Example 19, the subject matter of Examples 10-18 includes, wherein: the plurality of stacked layers consists of the bottom layer, an intermediate layer, and the upper layer, each layer having a thickness between 20 and 80 nm.

In Example 20, the subject matter of Example 19 includes, wherein: the plurality of stacked layers comprises: the bottom layer, having a width, in cross-section within the plane, between 250 and 350 nm; an intermediate layer, having a width, in cross-section within the plane, between 200 and 300 nm; and the upper layer, having a width, in cross-section within the plane, between 80 and 150 nm.

In Example 21, the subject matter of Examples 1-20 includes, wherein: the plurality of parallel grating lines share a common rising staircase angle and a common falling staircase angle.

In Example 22, the subject matter of Examples 1-21 includes, wherein: at least two of the plurality of parallel grating lines have different rising staircase angles.

In Example 23, the subject matter of Examples 1-22 includes, wherein: at least two of the plurality of parallel grating lines have different falling staircase angles.

In Example 24, the subject matter of Example 23 includes, wherein: the stepped diffraction grating is configured to propagate light along a light propagation path beginning at a first region and ending at a second region; and the parallel grating lines have a first falling staircase angle in the first region and a second falling staircase angle in the second region, the first falling staircase angle being closer to 90 degrees than the second falling staircase angle.

Example 25 is a stepped diffraction grating comprising: a plurality of parallel grating lines on a substrate surface, each grating line comprising: a plurality of stacked layers of optically transmissive material extending away from the substrate surface such that, in cross-section within a plane normal to the parallel grating lines, each grating line comprises: an upper layer having an upper surface at a grating height away from the substrate surface, the upper layer having a first end and a second end; a bottom layer having: a bottom surface abutting the substrate surface; and an upper surface having a first end and a second end; a rising staircase portion extending from the first end of the upper surface of the upper layer to the first end of the upper surface of the bottom layer at a rising staircase angle, defined relative to the substrate surface, between 10 degrees and 60 degrees; and a falling staircase portion extending from the second end of the upper surface of the upper layer to the second end of the upper surface of the bottom layer at a falling staircase angle, defined relative to the substrate surface, that is greater than the rising staircase angle and less than 80 degrees.

In Example 26, the subject matter of Example 25 includes, wherein: a falling staircase face of each layer defines, in cross-section within the plane, a layer edge angle with the substrate surface that is greater than the falling staircase angle and less than 90 degrees.

In Example 27, the subject matter of Examples 25-26 includes, a coating on each grating line.

In Example 28, the subject matter of Example 27 includes, wherein: the coating comprises a material having a high refractive index.

In Example 29, the subject matter of Example 28 includes, wherein: the material having the high refractive index comprises titanium dioxide (TiO2).

In Example 30, the subject matter of Examples 25-29 includes, wherein: the optically transmissive material comprises a transparent or partially transparent resin.

In Example 31, the subject matter of Examples 25-30 includes, wherein: the substrate surface is an upper surface of a waveguide body.

In Example 32, the subject matter of Examples 25-31 includes, wherein: the grating height is between 50 nm and 250 nm.

In Example 33, the subject matter of Example 32 includes, wherein: the stepped diffraction grating further comprises, between each adjacent pair of grating lines, a gap having a width between 10 nm and 130 nm.

In Example 34, the subject matter of Example 33 includes, wherein: the plurality of stacked layers consists of the bottom layer, an intermediate layer, and the upper layer, each layer having a thickness between 20 and 80 nm.

In Example 35, the subject matter of Example 34 includes, wherein: the plurality of stacked layers comprises: the bottom layer, having a width, in cross-section within the plane, between 250 and 350 nm; an intermediate layer, having a width, in cross-section within the plane, between 200 and 300 nm; and the upper layer, having a width, in cross-section within the plane, between 80 and 150 nm.

In Example 36, the subject matter of Examples 25-35 includes, wherein: the plurality of parallel grating lines share a common rising staircase angle and a common falling staircase angle.

In Example 37, the subject matter of Examples 25-36 includes, wherein: at least two of the plurality of parallel grating lines have different rising staircase angles.

In Example 38, the subject matter of Examples 25-37 includes, wherein: at least two of the plurality of parallel grating lines have different falling staircase angles.

In Example 39, the subject matter of Example 38 includes, wherein: the stepped diffraction grating is configured to propagate light along a light propagation path beginning at a first region and ending at a second region; and the parallel grating lines have a first falling staircase angle in the first region and a second falling staircase angle in the second region, the first falling staircase angle being closer to 90 degrees than the second falling staircase angle.

In Example 40, the subject matter of Examples 25-39 includes, wherein: the rising staircase angle is between 15 degrees and 45 degrees.

In Example 41, the subject matter of Examples 25-40 includes, wherein: the rising staircase angle is between 14 degrees and 30 degrees.

In Example 42, the subject matter of Examples 25-41 includes, wherein: the rising staircase angle is between 20 degrees and 25 degrees.

In Example 43, the subject matter of Examples 25-42 includes, wherein: the falling staircase angle is between 60 degrees and 89 degrees.

In Example 44, the subject matter of Examples 25-43 includes, wherein: the falling staircase angle is between 60 degrees and 70 degrees.

In Example 45, the subject matter of Examples 25-44 includes, wherein: the falling staircase angle is 65 degrees.

In Example 46, the subject matter of Examples 25-45 includes, wherein: the falling staircase angle is 80 degrees.

Example 47 is at least one machine-readable medium including instructions that, when executed by processing circuitry, cause the processing circuitry to perform operations to implement of any of Examples 1-46.

Example 48 is an apparatus comprising means to implement of any of Examples 1-46.

Example 49 is a system to implement of any of Examples 1-46.

Example 50 is a method to implement of any of Examples 1-46.

It will be appreciated that the various aspects of the methods described above may be combined in various combination or sub-combinations.

1. A method for manufacturing a stepped diffraction grating, comprising:
forming a plurality of parallel grating lines on a substrate surface, each grating line formed by:
forming a plurality of stacked layers of optically transmissive material extending away from the substrate surface such that, in cross-section within a plane normal to the parallel grating lines, each grating line comprises:
an upper layer having an upper surface at a grating height away from the substrate surface, the upper layer having a first end and a second end;
a bottom layer having:
a bottom surface abutting the substrate surface; and
an upper surface having a first end and a second end;
a rising staircase portion extending from the first end of the upper surface of the upper layer to the first end of the upper surface of the bottom layer at a rising staircase angle, defined relative to the substrate surface, between 10 degrees and 60 degrees; and
a falling staircase portion extending from the second end of the upper surface of the upper layer to the second end of the upper surface of the bottom layer at a falling staircase angle, defined relative to the substrate surface, that is greater than the rising staircase angle and less than 80 degrees.

2. The method of claim 1, wherein:
forming each grating line further comprises:
forming a master of the grating line by:
etching a master material from the grating height to the substrate surface in a first region, thereby forming a falling staircase face of the bottom layer extending to the substrate surface from the second end of the upper surface of the bottom layer; and
repeating, for each of one or more further layers including the upper layer:
etching the master material to an upper surface of a previously-formed layer in a further region, thereby forming a falling staircase face of the further layer above the previously-formed layer;
forming a working stamp over the master, an underside of the working stamp being shaped as a negative of an upper side of the master; and
imprinting the working stamp into the optically transmissive material to form the grating line.

3. The method of claim 2, further comprising, after forming the working stamp:
forming a metal layer on an underside of the working stamp.

4. The method of claim 2, wherein:
the falling staircase face of each layer defines, in cross-section within the plane, a layer edge angle with the substrate surface that is greater than the rising staircase angle and less than 90 degrees.

5. The method of claim 1, wherein forming each grating line further comprises, after forming the plurality of stacked layers:
depositing a coating on the grating line.

6. The method of claim 5, wherein:
the coating comprises a material having a high refractive index.

7. The method of claim 6, wherein:
the material having the high refractive index comprises titanium dioxide (TiO₂).

8. The method of claim 1, wherein:
the optically transmissive material comprises a transparent or partially transparent resin.

9. The method of claim 1, wherein:
the substrate surface is an upper surface of a waveguide body.

10. The method of claim 1, wherein:
the rising staircase angle is between 15 degrees and 45 degrees.

11. The method of claim 1, wherein:
the rising staircase angle is between 20 degrees and 25 degrees.

12. The method of claim 1, wherein:
the falling staircase angle is greater than 60 degrees and less than 80 degrees.

13. The method of claim 1, wherein:
the falling staircase angle is greater than 60 degrees and less than 70 degrees.

14. The method of claim 1, wherein:
the falling staircase angle is 65 degrees.

15. The method of claim 1, wherein:
the grating height is between 50 nm and 250 nm.

16. The method of claim 15, wherein:
the stepped diffraction grating further comprises, between each adjacent pair of grating lines, a gap having a width between 10 nm and 130 nm.

17. The method of claim 16, wherein:
the plurality of stacked layers consists of the bottom layer, an intermediate layer, and the upper layer, each layer having a thickness between 20 and 80 nm.

18. The method of claim 17, wherein:
the plurality of stacked layers comprises:
the bottom layer, having a width, in cross-section within the plane, between 250 and 350 nm;
an intermediate layer, having a width, in cross-section within the plane, between 200 and 300 nm; and
the upper layer, having a width, in cross-section within the plane, between 80 and 150 nm.

19. The method of claim 1, wherein:
the plurality of parallel grating lines share a common rising staircase angle and a common falling staircase angle.

20. The method of claim 1, wherein:
at least two of the plurality of parallel grating lines have different rising staircase angles.

21. The method of claim 1, wherein:
at least two of the plurality of parallel grating lines have different falling staircase angles.

22. The method of claim 21, wherein:
the stepped diffraction grating is configured to propagate light along a light propagation path beginning at a first region and ending at a second region; and
the parallel grating lines have a first falling staircase angle in the first region and a second falling staircase angle in the second region, the first falling staircase angle being closer to 90 degrees than the second falling staircase angle.

23. A stepped diffraction grating comprising:
a plurality of parallel grating lines on a substrate surface, each grating line comprising:
a plurality of stacked layers of optically transmissive material extending away from the substrate surface such that, in cross-section within a plane normal to the parallel grating lines, each grating line comprises:
an upper layer having an upper surface at a grating height away from the substrate surface, the upper layer having a first end and a second end;
a bottom layer having:
a bottom surface abutting the substrate surface; and
an upper surface having a first end and a second end;
a rising staircase portion extending from the first end of the upper surface of the upper layer to the first end of the upper surface of the bottom layer at a rising staircase angle, defined relative to the substrate surface, between 10 degrees and 60 degrees; and
a falling staircase portion extending from the second end of the upper surface of the upper layer to the second end of the upper surface of the bottom layer at a falling staircase angle, defined relative to the substrate surface, that is greater than the rising staircase angle and less than 80 degrees.
